(19) United States
(12) Patent Application Publication
(10) Pub. No.: US 2022/0122260 A1
(43) Pub. Date: Apr. 21, 2022

(54) METHOD AND APPARATUS FOR LABELING POINT CLOUD DATA, ELECTRONIC DEVICE, AND COMPUTER-READABLE STORAGE MEDIUM

(71) Applicant: SHENZHEN SENSETIME TECHNOLOGY CO., LTD., Shenzhen (CN)

(72) Inventors: Guorun YANG, Shenzhen (CN); Xiwen LIANG, Shenzhen (CN); Zhe WANG, Shenzhen (CN)

(21) Appl. No.: 17/529,749

(22) Filed: Nov. 18, 2021

Related U.S. Application Data
(63) Continuation of application No. PCT/CN2021/090660, filed on Apr. 28, 2021.

(30) Foreign Application Priority Data
Sep. 23, 2020 (CN) 202011010562.6

(51) Int. Cl. G06T 7/11; G06T 7/70; G06V 10/82; G06V 10/25; G06V 10/42

(52) U.S. Cl. CPC G06T 7/11; G06T 7/70; G06V 10/82; G06V 2201/07; G06V 10/421; G06T 2207/20084; G06T 2207/10028; G06V 10/25

(57) ABSTRACT

Provided are a method and apparatus for labeling point cloud data, an electronic device, and a computer-readable storage medium. In the embodiments, object recognition is firstly performed on to-be-recognized point cloud data to obtain a bounding box of an object in the to-be-recognized point cloud data; subsequently, to-be-labeled point cloud data is determined according to the bounding box of a recognized object in the to-be-recognized point cloud data; subsequently, a manual annotation box of an object in the to-be-labeled point cloud data is acquired; and finally annotation boxes of objects in the to-be-recognized point cloud data are determined according to the bounding box and the manual annotation box.

### CROSS-REFERENCE TO RELATED APPLICATIONS

This application is a continuation of International Application No. PCT/CN2021/090660 filed on Apr. 28, 2021, which is based on and claims priority to Chinese patent application No. 202011010562.6, filed on Sep. 23, 2020. The contents of these applications are hereby incorporated by reference in their entireties.

### BACKGROUND

Laser radar (Light Detection and Ranging, LiDAR) based 3D object detection is a core technology in the field of autonomous driving. Specifically, during object detection, point data on appearance of objects in an environment is firstly acquired by a laser radar to obtain point cloud data, and then the point cloud data is manually labeled to obtain annotation boxes of target objects.

Manual labeling of point cloud data has high labor costs, and the quality and quantity of point cloud labeling cannot be guaranteed, resulting in low detection accuracy of three-dimensional (3D) object detection.

### SUMMARY

The disclosure relates to the field of image processing, and particularly to a method and an apparatus for labeling point cloud data, an electronic device, and a computer-readable storage medium.

According to a first aspect, embodiments of the disclosure provide a method for labeling point cloud data, including: performing object recognition on to-be-recognized point cloud data to obtain a bounding box of an object in the to-be-recognized point cloud data; determining to-be-labeled point cloud data according to the bounding box of a recognized object in the to-be-recognized point cloud data; acquiring a manual annotation box of an object in the to-be-labeled point cloud data; and determining annotation boxes of objects in the to-be-recognized point cloud data according to the bounding box and the manual annotation box.

According to a second aspect, embodiments of the disclosure provide an apparatus for labeling point cloud data, including: an object recognition portion, configured to perform object recognition on to-be-recognized point cloud data to obtain a bounding box of an object in the to-be-recognized point cloud data; a point cloud processing portion, configured to determine to-be-labeled point cloud data according to the bounding box of a recognized object in the to-be-recognized point cloud data; an annotation box acquisition portion, configured to acquire a manual annotation box of an object in the to-be-labeled point cloud data; and an annotation box determination portion, configured to determine annotation boxes of objects in the to-be-recognized point cloud data according to the bounding box and the manual annotation box.

According to a third aspect, embodiments of the disclosure provide an electronic device, including: a processor, a memory, and a bus, where the memory stores machine-readable instructions executable by the processor, when the electronic device is miming, the processor communicates with the memory through the bus, and the machine-readable instructions are executed by the processor to perform following actions: performing object recognition on to-be-recognized point cloud data to obtain a bounding box of an object in the to-be-recognized point cloud data; determining to-be-labeled point cloud data according to the bounding box of a recognized object in the to-be-recognized point cloud data; acquiring a manual annotation box of an object in the to-be-labeled point cloud data; and determining annotation boxes of objects in the to-be-recognized point cloud data according to the bounding box and the manual annotation box.

According to a fourth aspect, embodiments of the disclosure provide a non-transitory computer-readable storage medium having stored thereon a computer program that, when executed by a processor, causes the processor to perform following actions: performing object recognition on to-be-recognized point cloud data to obtain a bounding box of an object in the to-be-recognized point cloud data; determining to-be-labeled point cloud data according to the bounding box of a recognized object in the to-be-recognized point cloud data; acquiring a manual annotation box of an object in the to-be-labeled point cloud data; and determining annotation boxes of objects in the to-be-recognized point cloud data according to the bounding box and the manual annotation box.

According to a fifth aspect, embodiments of the disclosure provide a computer program, including computer-readable codes that, when running on an electronic device, cause a processor in the electronic device to implement the actions in the foregoing method for labeling point cloud data.

To make the foregoing objectives, features, and advantages in the embodiments of the disclosure clearer and more comprehensible, detailed description is provided below with reference to preferred embodiments in conjunction with the accompanying drawings.

### BRIEF DESCRIPTION OF THE DRAWINGS

To describe the technical solutions of the embodiments of the disclosure more clearly, the accompanying drawings required for describing the embodiments are briefly introduced hereinafter. The accompanying drawings are incorporated in the specification and constitute a part of the specification. These accompanying drawings illustrate embodiments conforming to the disclosure, and are used together with the specification to describe the technical solutions in the embodiments of the disclosure. It should be understood that the accompanying drawings in the following illustrate merely some embodiments of the disclosure, and therefore should not be deemed as a limitation to the scope. A person of ordinary skill in the art may still derive other related drawings according to these accompanying drawings without creative efforts.

FIG. 1 illustrates a schematic diagram of architecture of a system for labeling point cloud data according to embodiments of the disclosure.

FIG. 2 illustrates a flowchart of a method for labeling point cloud data according to embodiments of the disclosure.

FIG. 3A illustrates a schematic diagram of point cloud data after object bounding boxes filtering according to embodiments of the disclosure.

FIG. 3B illustrates a schematic diagram of to-be-labeled point cloud data according to embodiments of the disclosure.

FIG. 3C illustrates a schematic diagram of remaining object bounding boxes obtained after filtering according to embodiments of the disclosure.

FIG. 3D illustrates a schematic diagram of point cloud data having subjected to manual labeling according to embodiments of the disclosure.

FIG. 3E illustrates a schematic diagram of point cloud data after a manual annotation box and an object bounding box are combined according to embodiments of the disclosure.

FIG. 4 illustrates a schematic structural diagram of an apparatus for labeling point cloud data according to embodiments of the disclosure.

FIG. 5 illustrates a schematic structural diagram of an electronic device according to embodiments of the disclosure.

### DETAILED DESCRIPTION

To make the objectives, technical solutions, and advantages in the embodiments of the disclosure clearer, the following clearly and completely describes the technical solutions in the embodiments of the disclosure with reference to the accompanying drawings in the embodiments of the disclosure. Apparently, the described embodiments are only some embodiments of the disclosure rather than all the embodiments. The components in the embodiments of the disclosure generally described and illustrated in the accompanying drawings herein may be arranged and designed in a variety of different configurations. Accordingly, the following detailed description of the embodiments of the disclosure provided in the accompanying drawings is not intended to limit the scope of the embodiments of the disclosure for which protection is claimed, but merely indicates selected embodiments of the embodiments of the disclosure. All other embodiments obtained by those skilled in the art based on the embodiments of the disclosure without creative efforts fall within the protection scope of the embodiments of the disclosure.

It should be noted that similar numerals and letters indicate similar items in the accompanying drawings below so that once defined in one accompanying drawing, an item does not need to be further defined or explained in subsequent accompanying drawings.

The term “and/or” in this specification describes only an association relationship and represents that three relationships may exist. For example, A and/or B may represent the following three cases: only A exists, both A and B exist, and only B exists. In addition, the term “at least one of” herein means any one of a plurality or any combination of at least two of a plurality, for example, including at least one of A. B, or C may mean including any one or more elements selected from the set consisting of A, B, and C.

LiDAR-based 3D object detection algorithms are core technology in the field of autonomous driving. A set of point data, that is, a point cloud (including information such as three-dimensional coordinates and laser reflection intensity) on the appearance of an object in an environment is acquired by a laser radar. A LiDAR-based 3D object detection algorithm mainly lies in detecting information such as 3D geometric information of an object in a point cloud space, which mainly includes a length, a width, a height, a center point, and orientation angle information of the object. With the popularity of devices such as 3D sensors in mobile devices and smart cars, it is increasingly easier to obtain point cloud data of 3D scenes. In the related art, the LiDAR based 3D object detection algorithms mostly rely on manually labeled label data. It is very expensive to manually label a large amount of point cloud data, and the quality and quantity of labeled data severely affect the performance of the 3D object detection algorithms. That is, in the related art, manual labeling of point cloud data requires high costs and has relatively low quality and speed.

The disclosure provides a method for labeling point cloud data. In the embodiments of the disclosure, a bounding box of an object obtained by automatically labeling point cloud data and a manual annotation box obtained by manually labeling point cloud data remained after the point cloud data is automatically labeled are combined, so that annotation boxes of objects can be accurately determined, thereby increasing a labeling speed and reducing a labeling cost. The qualify and quantity of point cloud labeling can be improved, so as to improve the detection accuracy of 3D object detection.

A method and apparatus for labeling point cloud data, an electronic device, and a computer-readable storage medium disclosed in the embodiments of the disclosure are described below through specific embodiments.

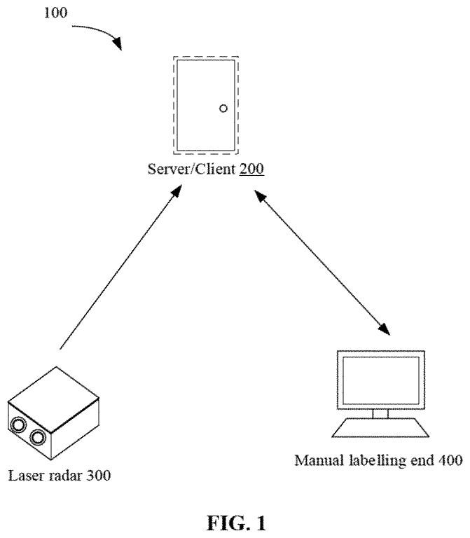

FIG. 1 illustrates a schematic diagram of an optional architecture of a system 100 for labeling point cloud data according to embodiments of the disclosure. The system 100 for labeling point cloud data includes a server/client 200, a laser radar 300, and a manual labeling end 400. The laser radar 300 (for example, FIG. 1 exemplarily illustrates one laser radar) is configured to acquire point cloud data on the appearance of an object in an environment, so as to obtain to-be-recognized point cloud data, and sends the to-be-recognized point cloud data to the server/client 200. The server/client 200 performs object recognition on the to-be-recognized point cloud data received from the laser radar to obtain a bounding box of an object in the to-be-recognized point cloud data, determines to-be-labeled point cloud data according to the bounding box of a recognized object in the to-be-recognized point cloud data, and sends the to-be-labeled point cloud data to the manual labeling end 400 (for example, FIG. 1 exemplarily illustrates one manual labeling end). The manual labeling end 400 generates a manual annotation box for the to-be-labeled point cloud data according to a labeling operation of a working staff, and sends the generated manual annotation box to the server/client 200 according to a sending instruction of the working staff. The server/client 200 acquires the manual annotation box of an object in the to-be-labeled point cloud data, and determines annotation boxes of objects in the to-be-recognized point cloud data according to the bounding box and the manual annotation box.

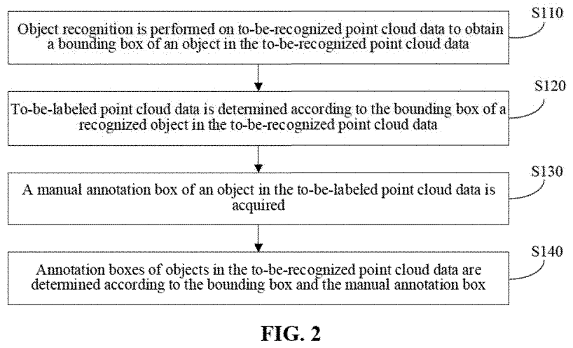

FIG. 2 illustrates a flowchart of a method for labeling point cloud data according to embodiments of the disclosure. As illustrated in FIG. 2, embodiments of the disclosure disclose a method for labeling point cloud data. The method is applicable to a server or a client, and is used for performing object recognition on acquired to-be-recognized point cloud data and determining annotation boxes of objects. The method for labeling point cloud data may include the following actions.

In S110, object recognition is performed on to-be-recognized point cloud data to obtain a bounding box of an object in the to-be-recognized point cloud data.

Herein, object recognition may be performed on the to-be-recognized point cloud data by using a trained neural network, to obtain a bounding box of at least one object.

In addition, while object recognition is performed by the neural network to obtain the bounding box of the object, a confidence corresponding to each bounding box of object may be further obtained. A class of object corresponding to a bounding box may be a vehicle, a walking pedestrian, a cyclist, a truck, or the like. Bounding boxes of objects of different classes have different confidence thresholds.

The neural network may be obtained by training with manually labeled point cloud data samples. The point cloud data samples include sample point cloud data and bounding boxes obtained by manually labeling the sample point cloud data.

The to-be-recognized point cloud data may be a set of point cloud data obtained by performing detection on a preset region by using a laser radar.

Automatically performing object recognition and determining the confidence of the bounding box based on the trained neural network can improve the accuracy and. speed of object recognition, thereby reducing the instability brought about by manual labeling.

In S120, to-be-labeled point cloud data is determined according to the bounding box of a recognized object in the to-be-recognized point cloud data.

While performing object recognition on the to-be-recognized point cloud data to determine the bounding box, the neural network generates the confidence of each bounding box. Herein, the to-be-labeled point cloud data may be determined b using the following sub-actions: a bounding box with a confidence less than a confidence threshold is eliminated according to the confidence of the bounding box of the recognized object to obtain a remaining bounding box; and point cloud data outside the remaining bounding box in the to-be-recognized point cloud data is taken as the to-be-labeled point cloud data.

Eliminating an automatic labeling result of point cloud data with relatively low recognition accuracy by using a preset confidence threshold helps to improve the quality of point cloud data labeling.

The neural network has different accuracies in detecting different classes of objects. Therefore, if elimination of bounding boxes is performed by using the same confidence for objects of all classes, the accuracy of remaining bounding boxes is reduced. Therefore, different confidence thresholds may be preset far bounding boxes of objects of different classes according to accuracies of the neural network in detecting objects of different classes.

For example, a confidence threshold of 0.81 is set for bounding boxes of objects corresponding to a class of vehicle, a confidence threshold of 0.70 is set for bounding boxes of objects corresponding to a class of walking pedestrian, a confidence threshold of 0.72 is set for bounding boxes of objects corresponding to a class of cyclist, and a confidence threshold of 0.83 is set for bounding boxes of objects corresponding to a class of coach.

By setting a confidence threshold based on the accuracy of object recognition of the neural network, an inaccurate bounding box can be effectively eliminated, thereby improving the accuracy of remaining bounding boxes, and the accuracy of an annotation box of object determined based on the remaining bounding boxes can be improved.

After different confidence thresholds are set, a bounding box with a confidence less than a confidence threshold may be eliminated according to the confidence of the bounding box of the recognized object to obtain a remaining bounding box through the following actions: for each bounding box, in response to that a confidence of the bounding box is greater than or equal to a confidence threshold corresponding to a class of an object in the bounding box, the bounding box is determined as a remaining bounding box; and for each bounding box, in response to that the confidence of the bounding box is less than the confidence threshold corresponding to the class of the object in the bounding box, the bounding box eliminated.

Based on a confidence threshold matching a class of object, a bounding box that corresponds to the class of object and has a relatively low confidence is eliminated, thereby improving the quality of automatic labeling of point cloud data.

The bounding box includes point cloud data of a corresponding object acquired by a laser radar.

In S130, a manual annotation box of an object in the to-be-labeled point cloud data is acquired.

Some annotation boxes of objects that need to be labeled may be missed in automatic labeling of bounding boxes of objects. Therefore, point cloud data other than point cloud data framed by the bounding boxes of objects needs to be manually labeled, and a manual annotation box may be obtained through manual labeling. The bounding boxes of objects obtained through automatic detection and manual annotation boxes obtained through manual labeling can comprehensively and accurately represent objects in a point cloud data set.

Herein, a manual annotation box may be acquired through the following actions.

The to-be-labeled point cloud data is sent to the manual labeling end, so that working staff manually labels the to-be-labeled point cloud data through the manual labeling end, to obtain the manual annotation box The manual labeling end sends the manual annotation box to a server or client. The server or client receives the manual annotation box.

Remaining point cloud data other than point cloud data framed by the bounding boxes of object obtained through automatic labeling is sent to the manual labeling end, to acquire a manual annotation box of the remaining point cloud data, thereby reducing the amount of point cloud data needing to be manually labeled and reducing costs. This helps to improve the quality of point cloud data labeling, and improve the speed in labeling point cloud data.

The point cloud data framed by the bounding box of the object includes point cloud data located inside the bounding box and point cloud data located on the surface of the bounding box.

The manual annotation box includes point cloud data of a corresponding object acquired by a laser radar.

In S140, annotation boxes of objects in the to-be-recognized point cloud data are determined according to the hounding box and the manual annotation box.

Herein, the annotation boxes of the objects in the to-be-recognized point cloud data may be determined according to the remaining bounding box and the manual annotation box.

By determining the annotation boxes of objects in the to-be-recognized point cloud data on a bounding box with a relatively higher confidence, the quality of point cloud labeling is improved.

Herein, the remaining bounding box of object and the manual annotation box may be directly combined to obtain the annotation boxes of the objects.

A manual annotation box largely overlapped with a bounding box of the object may be alternatively eliminated to obtain a remaining annotation box by using the following actions, and the remaining bounding box and the remaining manual annotation box are then combined as the annotation boxes of the objects in the to-be-recognized point cloud data.

Firstly for each remaining bounding box of object, it is detected whether there is a manual annotation box that partially or completely overlaps with the bounding box of object. In a case that there is a manual annotation box at least partially overlapping the bounding box of object, the bounding box of object and the manual annotation box at least partially overlapping the bounding box are used as one annotation box pair. Next, for each annotation box pair, an Intersection over Union (IoU) between the remaining bounding box and the manual annotation box in the annotation box pair is determined, and when the IoU is greater than a preset threshold, the manual annotation box in the annotation box pair is eliminated.

When there is an overlap between a bounding box of object obtained through automatic detection and a manual annotation box obtained through manual labeling, the manual annotation box is eliminated based on the IoU between the bounding box and the manual annotation box and a preset threshold, so that the accuracy of object labeling can be improved.

During particular implementation, the IoU may be determined by using the following actions. Firstly, an intersection between point cloud data framed by the remaining bounding box in the annotation box pair and point cloud data framed by the manual annotation box in the annotation box pair is determined. A union between the point cloud data framed by the remaining bounding box in the annotation box pair and the point cloud data framed by the manual annotation box in the annotation box pair is determined. Subsequently, the IoU between the remaining bounding box and the manual annotation box in the annotation box pair is determined based on the union and the intersection. A quotient of the intersection being divided by the union may be calculated to serve as the IoU.

By using the intersection and the union between the point cloud data framed by the bounding box of object and point cloud data framed by the manual annotation box, an IoU between the bounding box of object and the manual annotation box can be accurately determined.

In summary, the method for labeling point cloud data provided in the embodiments of the disclosure may specifically include the following actions.

Action 1, object recognition is performed on the to-be-recognized point cloud data by using a pre-trained neural network, to obtain a bounding box of at least one object and a confidence corresponding to each bounding box.

The to-be-recognized point cloud data may include point cloud data acquired by a laser radar in one data frame.

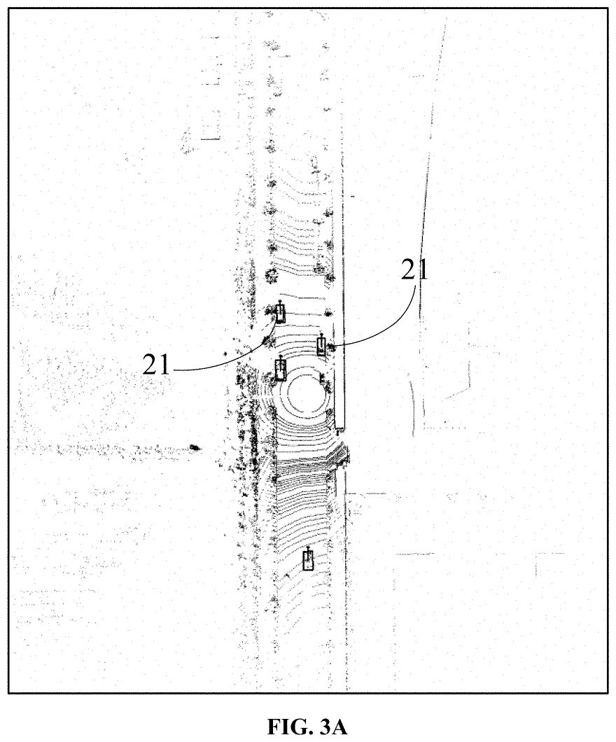

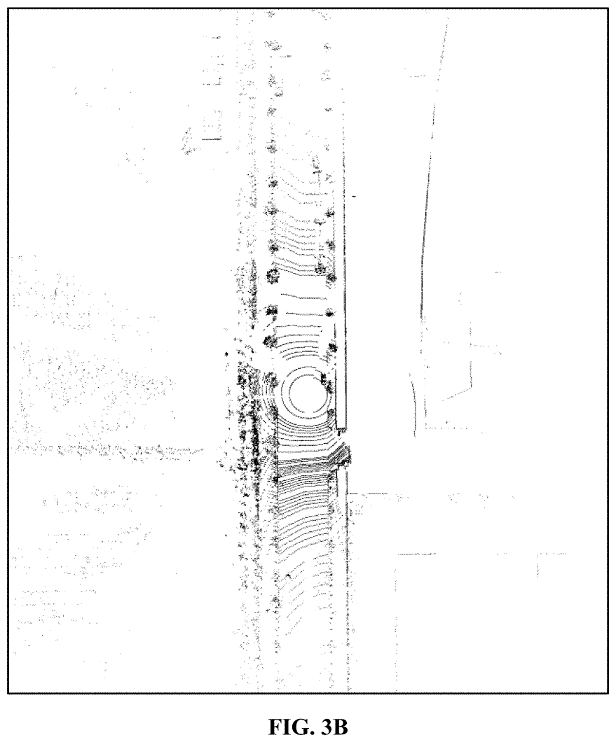

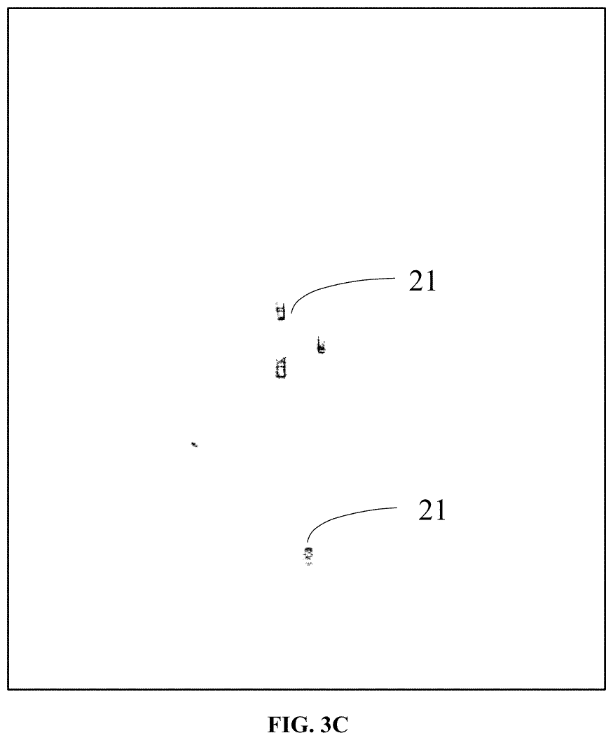

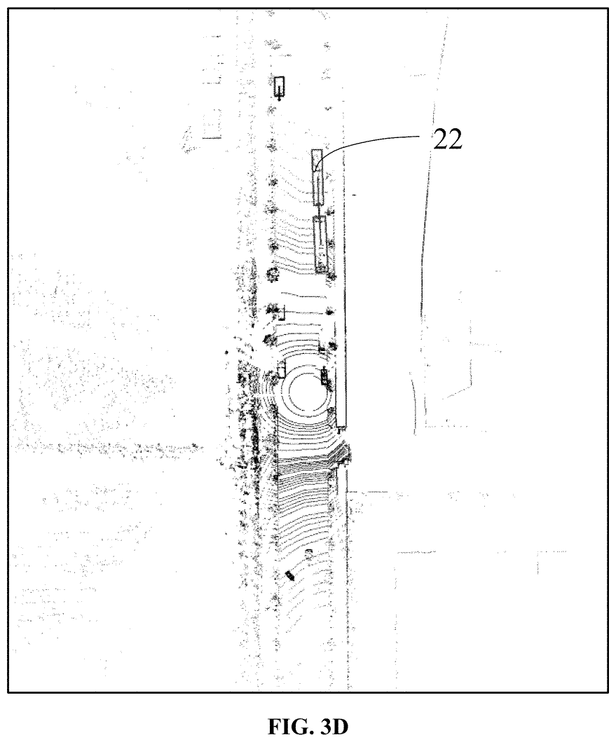

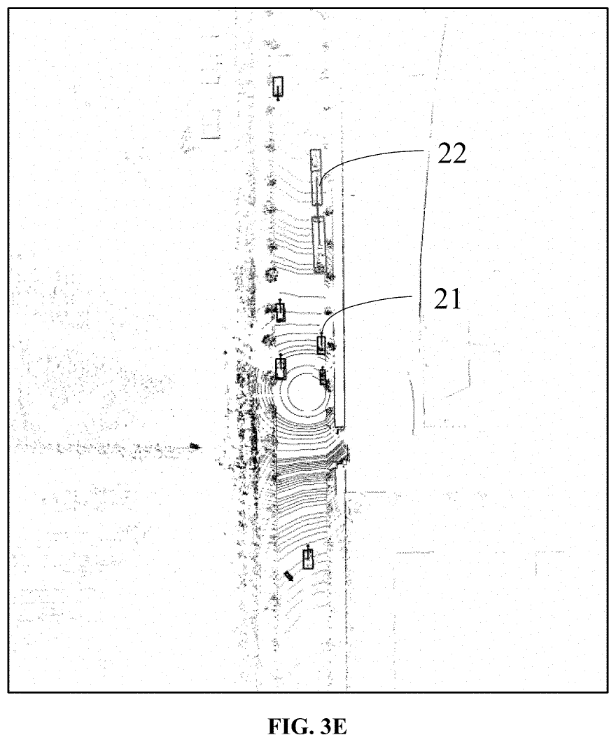

Action 2, for a bounding box corresponding to each class of object, a confidence threshold is determined according to a recognition accuracy of the neural network for the class of object. By using the confidence threshold, a bounding box with a confidence less than a corresponding confidence threshold is eliminated from the bounding box of object obtained in the previous step, and the recognition accuracy of the remaining bounding box is relatively high. As illustrated in FIG. 3A, the remaining bounding boxes 21 are already relatively accurate.

Action 3, point cloud data other than the point cloud data framed by the remaining hounding box in the to-be-recognized point cloud data is sent to the manual labeling end as the to-be-labeled point cloud data, for manual labeling. For all bounding boxes in the same frame, point cloud data in the frame is divided into two parts after filtering. One part is point cloud inside these bounding boxes and on the surface of the bounding boxes, and the other part is point cloud data outside the bounding boxes. The two parts are respectively stored for use in subsequent manual labeling and data combination actions. FIG. 3B illustrates the to-be-labeled point cloud data (that is, point cloud data outside bounding boxes that are remained after filtering in the flame). FIG. 3C illustrates the foregoing remaining bounding boxes (that is, point cloud data inside the bounding boxes and on the surface of the bounding boxes that are remained after filtering in the frame). The to-be-recognized point cloud data (that is, original point cloud data of the frame) can be obtained by combining the point cloud data in FIG. 3B and the point cloud data in FIG. 3C.

During particular implementation, an image only including the to-be-labeled point cloud data may be sent to the manual labeling end or an image labeled with the remaining bounding boxes may be sent to the manual labeling end.

Action 4, a working staff performs manual labeling at the manual labeling end, as illustrated in FIG. 3D, to obtain a manual annotation box 22 of a frame.

Action 5, the remaining bounding box of object is concatenated to the manual annotation box to obtain complete labeling data, that is, to obtain the annotation boxes of objects. In this process, some manual annotation box may be overlapped with a remaining bounding box due to inadequate point cloud filtering. Therefore, an IOU needs to be calculated for a manual annotation box and a bounding box that have an overlap therebetween. If the IoU between the manual annotation box and the bounding box is greater than the preset threshold, for example, 0.7, the manual annotation box is eliminated. Cleaned manual annotation boxes are obtained through this action, and then the cleaned manual annotation boxes obtained and the remaining bounding boxes are combined to obtain complete label data, that is, annotation boxes of objects, as illustrated by a marker 21 and a marker 22 in FIG. 3E.

In the related art, during automatic generation of label data, a large amount of label data can be generated. However, some dirty data may be generated which causes noise to a data set. The automatic generation is not worthwhile if there is too much dirty data. For this, in the method for labeling point cloud data provided in the embodiments of the disclosure, a bounding box of object generated through automatic detection and a manual annotation box obtained through manual labeling are combined to determine the annotation boxes of objects, so that the accuracy and speed of object labeling are further improved while the labeling cost is reduced. A point cloud labeling result with relatively high quality can be obtained at a relatively low cost.

The method in the embodiments of the disclosure is applicable to autonomous driving, 3D object detection, depth prediction, scene modeling, among other fields, and is specifically applicable to the acquisition of a LiDAR-based 3D scene data set.

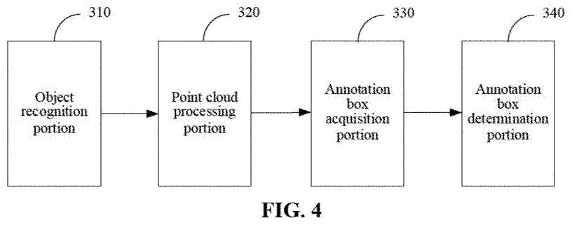

Corresponding to the foregoing method for labeling point cloud data, embodiments of the disclosure further disclose an apparatus for labeling point cloud data, applied to a server or a client. The parts in the apparatus can implement actions in the method for labeling point cloud data in the foregoing embodiments, and can achieve the same beneficial effect. As illustrated in FIG. 4, the apparatus for labeling point cloud data includes: an object recognition portion 310, a point cloud processing portion 320, an annotation box acquisition portion 330, and an annotation box determination portion 340.

The object recognition portion 310 is configured to perform object recognition on to-be-recognized point cloud data to obtain a bounding box of an object in the to-be-recognized point cloud data. The point cloud processing portion 320 is configured to determine to-be-labeled point cloud data according to the bounding box of a recognized object in the to-be-recognized point cloud data. The annotation box acquisition portion 330 is configured to acquire a manual annotation box of an object in the to-be-labeled point cloud data. The annotation box determination portion 340 is configured to determine annotation boxes of objects in the to-be-recognized point cloud data according to the bounding box and the manual annotation box.

In some embodiments, the object recognition portion 310 is further configured to perform the object recognition on the to-be-recognized point cloud data, to obtain a confidence of the bounding box of the recognized object

In determining to-be-labeled point cloud data according to the bounding box of a recognized object in the to-be-recognized point cloud data, the point cloud processing portion 320 is configured to: a bounding box with a confidence less than a confidence threshold according to the confidence of the bounding box of the recognized object to obtain a remaining bounding box; and take point cloud data outside the remaining bounding box in the to-be-recognized point cloud data as the to-be-labeled point cloud data.

In some embodiments, in determining annotation boxes of objects in the to-be-recognized point cloud data according to the bounding box and the manual annotation box, the annotation box determination portion 340 is configured to: determine the annotation boxes of the objects in the to-be-recognized point cloud data according to the remaining bounding box and the manual annotation box.

In some embodiments, for each class of object, a bounding box corresponds to a respective different confidence threshold. In eliminating a bounding box with a confidence less than a confidence threshold according to the confidence of the bounding box of the recognized object to obtain a remaining bounding box, the point cloud processing portion 320 is configured to: for each bounding box, in response to that a confidence of the hounding box is greater than or equal to a confidence threshold corresponding to a class of an object in the bounding box, determine the bounding box as a remaining bounding box.

In some embodiments, the point cloud processing portion 320 is further configured to: for each bounding box, in response to that the confidence of the bounding box is less than the confidence threshold corresponding to the class of the object in the bounding box, eliminate the bounding box.

In some embodiments, in determining the annotation boxes of the objects in the to-be-recognized point cloud data according to the remaining bounding box and the manual annotation box, the annotation box determination portion 340 is configured to: for each remaining bounding box, in response to that there is a manual annotation box at least partially overlapping the remaining bounding box, take the remaining bounding box and the manual annotation box at least partially overlapping the remaining bounding box as an annotation box pair; for each annotation box pair, determine an Intersection over Union (IoU) between a remaining bounding box and a manual annotation box in the annotation box pair, and eliminate the manual annotation box in the annotation box pair in response to that the IoU is greater than a preset threshold, to obtain a remaining manual annotation box; and taking the remaining bounding box and the remaining manual annotation box as the annotation boxes of the objects in the to-be-recognized. point cloud data.

In some embodiments, in determining an IoU between the remaining bounding box and the manual annotation box in the annotation box pair. the annotation box determination portion 340 is configured to: determine an intersection between point cloud data framed by the remaining bounding box in the annotation box pair and point cloud data framed by the manual annotation box in the annotation box pair; determine a union of the point cloud data framed by the remaining bounding box in the annotation box pair and the point cloud data framed by the manual annotation box in the annotation box pair; and determine the IoU between the remaining bounding box and the manual annotation box in the annotation box pair based on the union and the intersection

In some embodiments, in performing object recognition on to-be-recognized point cloud data to obtain a bounding box of an object in the to-be-recognized point cloud data, the object recognition portion 310 is configured to: performing, by a neural network that has been trained, object recognition on the to-be-recognized point cloud data, and outputting, by the neural network, the bounding box of the recognized object.

In some embodiments, the neural network further outputs a confidence of each bounding box.

In the embodiments of the disclosure and in other embodiments, a “portion” may be a part of a circuit, a part of a processor, a part of a program or software, or the like, or certainly may be a unit or may be modular or non-modular.

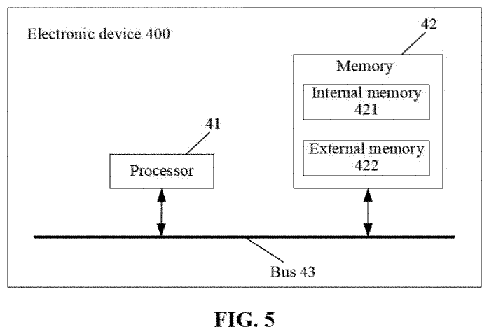

Corresponding to the foregoing method for labeling point cloud data, embodiments of the disclosure further provide an electronic device 400. FIG. 5 illustrates a schematic structural diagram of the electronic device 400 according to embodiments of the disclosure.

The electronic device 400 includes: a processor 41, a memory 42, and a bus 43.

The memory 42 is configured to store execution instructions, and includes an internal memory 421 and an external memory 422. The internal memory 421 herein is configured to temporarily store operation data in the processor 41 and data exchanged with the external memory 422 such as a hard disk. The processor 41 exchanges data with the external memory 422 through the internal memory 421. When the electronic device 400 is running, the processor 41 communicates with the memory 42 through the bus 43, to enable the processor 41 to perform the following instructions: performing object recognition onto-be-recognized point cloud data to obtain a bounding box of an object in the to-be-recognized point cloud data; determining to-be-labeled point cloud data according to the bounding box of a recognized object in the to-be-recognized point cloud data; acquiring a manual annotation box of an object in the to-be-labeled point cloud data; and finally, determining annotation boxes of objects in the to-be-recognized point cloud data according to the bounding box and the manual annotation box.

Embodiments of the disclosure further provide a computer-readable storage medium having stored thereon a computer program that, when executed by a processor, causes the processor to perform the actions in the method for labeling point cloud data in the foregoing method embodiments. The storage medium may be a volatile or non-volatile computer-readable storage medium.

The computer-readable storage medium may be a tangible device that holds and stores instructions used by an instruction execution device, and may be a volatile storage medium or a non-volatile storage medium. The computer-readable storage medium may be, for example, but not limited to, an electric storage device, a magnetic storage device, an optical storage device, an electromagnetic storage device, a semiconductor storage device, or any suitable combination of the above. More specific examples of the computer-readable storage medium (a non-exhaustive list) include: a portable computer disk, a hard disk, a random access memory (RAM), a read-only memory (ROM), an erasable programmable read-only memory (EPROM or flash memory), a static random memory reader (ROM), a portable compact disc read-only memory (CD-ROM), a digital versatile disc (DVD), a memory stick, a floppy disk, a mnemonic coding device, such as punched cards or recessed structures with instructions stored thereon, and any suitable combination of the above. The computer-readable storage medium used herein is not to be interpreted as transient signals per se, such as radio waves or other freely propagating electromagnetic waves, electromagnetic waves propagating through waveguides or other media mediums (for example, a light pulse through a fiber optic cable), or electrical signals transmitted through wires.

A computer program product corresponding to the method for labeling point cloud data provided in the embodiments of the disclosure includes a computer-readable storage medium on which program code is stored. The instructions included in the program code may be configured to perform the actions in the method for labeling point cloud data in the foregoing method embodiments. For details, reference may be made to the foregoing method embodiments, which not be described herein again.

Embodiments of the disclosure further provide a computer program that, when executed by a processor, causes the processor to perform any method for labeling point cloud data in the foregoing embodiments. The computer program product may be specifically implemented through hardware, software, or a combination thereof. In some embodiments, the computer program product is specifically embodied as a computer-readable storage medium. In some other embodiment, the computer program product is specifically embodied as a software product, for example, a Software Development Kit (SDK).

It may be clearly understood by a person skilled in the art that, for the purpose of convenience and brief description, for a detailed working process of the foregoing system and apparatus, reference may be made to a corresponding process in the foregoing method embodiments. In the several embodiments provided in the embodiments of the disclosure, it should be understood that the disclosed system, apparatus, and method may be implemented in other forms. The described apparatus embodiments are merely exemplary. For example, the division of units is merely division in logical functions and may be division in other forms in actual implementation. In another example, multiple units or components may be combined or integrated into another system, or some features may be ignored or not performed. In addition, the shown or discussed mutual couplings or direct couplings or communication connections may be indirect couplings or communication connections implemented through some communication interfaces, apparatuses or units, or may be electrical, mechanical, or in other forms.

The units described as separate parts may or may not be physically separate, and parts shown as units may or may not be physical units, that is, may be located in one position, or may be distributed on multiple network units. Some or all of the units may be selected according to actual needs to achieve the objectives of the solutions in the embodiments.

In addition, functional units in the embodiments of the disclosure may be integrated into one processing unit, or each of the units may exist alone physically, or two or more units are integrated into one unit.

When implemented in the form of a software functional unit and sold or used as an independent product, the functions may be stored in a non-volatile computer-readable storage medium executable by a processor. Based on such an understanding, the technical solutions in the embodiments of the disclosure essentially, or the part contributing to the prior art, or some of the technical solutions may be implemented in the form of a software product. The software product is stored in a storage medium and includes several instructions for instructing a computer device (which may be a personal computer, a server, a network device or the like) to perform all or some of the actions of the method described in the embodiments of the disclosure. The foregoing storage medium includes various media that can store program code, such as a Universal Serial Bus (USB) flash drive, a removable hard disk, a ROM, a RAM, a magnetic disk or an optical disc.

Finally, it should be noted that the foregoing embodiments are merely particular implementations of the disclosure, and are intended for describing the technical solutions of the disclosure rather than limiting the disclosure. The scope of protection of the disclosure is not limited thereto. Although the disclosure is described in detail with reference to the foregoing embodiments, those of ordinary skill in the art should understand that any person skilled in the art may still make modifications or readily conceivable changes to the technical solutions described in the foregoing embodiments or make equivalent replacements to some the technical features thereof within the technical scope disclosed in the disclosure. Such modifications, changes, or replacements do not cause the essence of the corresponding technical solutions to depart from the spirit and scope of the technical solutions of the embodiments of the disclosure, and shall all fall within the scope of protection of the disclosure. Therefore, the scope of protection of the disclosure shall be subject to the protection scope of the claims.

### INDUSTRIAL APPLICABILITY

Embodiments of the disclosure provide a method and apparatus for labeling point cloud data, an electronic device, and a computer-readable storage medium. In the embodiments of the disclosure, object recognition is firstly performed on to-be-recognized point cloud data to obtain a bounding box of an object in the to-be-recognized point cloud data; subsequently to-be-labeled point cloud data is determined according to the bounding box of a recognized object in the to-be-recognized point cloud data; next, a manual annotation box of an object in the to-be-labeled point cloud data is acquired; and finally, annotation boxes of objects in the to-be-recognized point cloud data is determined according to the bounding box and the manual annotation box. In the embodiments of the disclosure, a bounding box of an object obtained by automatically labeling point cloud data and a manual annotation box obtained by manually labeling point cloud data remained after the point cloud data is automatically labeled are combined, so that annotation boxes of objects can be accurately determined, thereby increasing a labeling speed and reducing a labeling cost.

1. A method for labeling point cloud data, comprising:
performing object recognition on to-be-recognized point cloud data to obtain a bounding box of an object in the to-be-recognized point cloud data;
determining to-be-labeled point cloud data according to the bounding box of a recognized object in the to-be-recognized point cloud data;
acquiring a manual annotation box of an object in the to-be-labeled point cloud data; and
determining annotation boxes of objects in the to-be-recognized point cloud data according to the hounding box and the manual annotation box.

2. The method according to claim 1, further comprising:
performing the object recognition on the to-be-recognized point cloud a to obtain a confidence of the bounding box of the recognized object; and
the determining to-be-labeled point cloud data according to the bounding box of the recognized object in the to-be-recognized point cloud data comprises:
eliminating a bounding box with a confidence less than a confidence threshold according to the confidence of the bounding box of the recognized object to obtain a remaining hounding box; and
taking point cloud data outside the remaining bounding box in the to-be-recognized point cloud data as the to-be-labeled point cloud data.

3. The method according to claim 2, wherein the determining annotation boxes of objects in the to-be-recognized point cloud data according to the bounding box and the manual annotation box comprises:
determining the annotation boxes of the objects in the to-be-recognized point cloud data according to the remaining bounding box and the manual annotation box.

4. The method according to claim 2, wherein for each class of object, a bounding box corresponds to a respective different confidence threshold; and
the eliminating a bounding box with a confidence less than a confidence threshold according to the confidence of the bounding box of the recognized object to obtain a remaining bounding box comprises:
for each bounding box, in response to that a confidence of the bounding box is greater than or equal to a confidence threshold corresponding to a class of an object in the bounding box, determining the bounding box as a remaining bounding box.

5. The method according to claim 4, further comprising:
for each bounding box, in response to that the confidence of the bounding box is less than the confidence threshold corresponding to the class of the object in the bounding box, eliminating the bounding box.

6. The method according to claim 3, wherein the determining the annotation boxes of the objects in the to-be-recognized point cloud data according to the remaining bounding box and the manual annotation box comprises:
for each remaining bounding box, in response to that there is a manual annotation box at least partially overlapping the remaining bounding box, taking the remaining bounding box and the manual annotation box at least partially overlapping the remaining bounding box as an annotation box pair;
for each annotation box pair, determining an intersection over union (IoU) between a remaining bounding box and a manual annotation box in the annotation box pair, and eliminating the manual annotation box in the annotation box pair in response to that the IoU is greater than a preset threshold, to obtain a remaining manual annotation box; and
taking the remaining bounding box and the remaining manual annotation box as the annotation boxes of the objects in the to-be-recognized point cloud data.

7. The method according to claim 6, wherein the determining an IoU between the remaining bounding box and the manual annotation box in the annotation box pair comprises:
determining an intersection between point cloud data framed by the remaining bounding box in the annotation box pair and point cloud data framed by the manual annotation box in the annotation box pair;
determining a union of the point cloud data framed by the remaining bounding box in the annotation box pair and the point cloud data framed by the manual annotation box in the annotation box pair; and
determining the IoU between the remaining bounding box and the manual annotation box in the annotation box pair based on the union and the intersection.

8. The method according to claim 1, wherein the performing object recognition on to-be-recognized point cloud data to obtain a bounding box of an object in the to-be-recognized point cloud data comprises:
performing, by a neural network that has been rained, object recognition on the to-be-recognized point cloud data, and
outputting, by the neural network, the bounding box recognized object.

9. The method according to claim 8, further comprising:
outputting, by the neural network, a confidence of each bounding box.

11. An electronic device, comprising: a processor, a memory, and a bus, wherein the memory stores machine-readable instructions executable by the processor, when the electronic device is running, the processor communicates with the memory through the bus, and the machine-readable instructions are executed by the processor to perform following actions:
performing object recognition on to-be-recognized point cloud data to obtain a bounding box of an object in the to-be-recognized point cloud data;
determining to-be-labeled point cloud data according to the bounding box of a recognized object in the to-be-recognized point cloud data;
acquiring a manual annotation box of an object in the to-be-labeled point cloud data; and
determining annotation boxes of objects in the to-be-recognized point cloud data according to the bounding box and the manual annotation box.

11. The electronic device according to claim 10, Wherein the machine-readable instructions are executed by the processor to further perform following:
performing the object recognition on the to-be-recognized point cloud data to obtain a confidence of the bounding box of the recognized object; and
in the determining to-be-labeled point cloud data according to the bounding box of the recognized object in the to-be-recognized point cloud data, the machine-readable instructions are executed by the processor to perform following:
eliminating a bounding box with a confidence less than a confidence threshold according, to the confidence of the bounding box of the recognized object to obtain a remaining bounding box; and
taking point cloud data outside the remaining bounding box in the to-be-recognized point cloud data as the to-be-labeled point cloud data.

12. The electronic device according to claim 11, in the determining annotation boxes of objects in the to-be-recognized point cloud data according to the bounding box and the manual annotation box, the machine-readable instructions are executed by the processor to perform following:
determining the annotation boxes of the objects in the to-be-recognized point cloud. data according to the remaining bounding box and the manual annotation box.

13. The electronic device according to claim 11, wherein for each class of object, a bounding box corresponds to a respective different confidence threshold; and
in the eliminating a bounding box with a confidence less than a confidence threshold according to the confidence of the bounding box of the recognized object to obtain a remaining bounding box, the machine-readable instructions are executed by the processor to perform following:
for each bounding box, in response to that a confidence of the bounding box is greater than or equal to a confidence threshold corresponding to a class of an object in the bounding box, determining the bounding box as a remaining bounding box.

14. The electronic device according to claim 13, wherein the machine-readable instructions are executed by the processor to further perform following:
for each bounding box, in response to that the confidence of the bounding box is less than the confidence threshold corresponding to the class of the object in the bounding box, eliminating the bounding box.

15. The method according to claim 12, wherein in the determining the annotation boxes of the objects in the to-be-recognized point cloud data according to the remaining bounding box and the manual annotation box, the machine-readable instructions are executed by the processor to perform following:
for each remaining bounding box, in response to that there is a manual annotation box at least partially overlapping the remaining bounding box, taking the remaining bounding box and the manual annotation box at least partially overlapping the remaining bounding box as an annotation box pair:
for each annotation box pair, determining an intersection over union (IoU) between a remaining bounding box and a manual annotation box in the annotation box pair, and eliminating the manual annotation box in the annotation box pair in response to that the IoU is greater than a preset threshold, to obtain a remaining manual annotation box: and
taking the remaining bounding box and the remaining manual annotation box as the annotation boxes of the objects in the to-be-recognized point cloud data.

16. The electronic device according to claim 15, wherein in the determining an IoU between the remaining bounding box and the manual annotation box in the annotation box pair, the machine-readable instructions are executed by the processor to perform following:
determining an intersection between point cloud data framed by the remaining bounding box in the annotation box pair and point cloud data, framed by the manual annotation box in the annotation box pair;
determining a union of the point cloud data framed by the remaining bounding box in the annotation box pair and the point cloud data framed by the manual annotation box in the annotation box pair; and
determining the IoU between the remaining bounding box and the manual annotation box in the annotation box pair based on the union and the intersection.

17. The electronic device according to claim 10, wherein in the performing object recognition on to-be-recognized point cloud data to obtain a bounding box of an object in the to-be-recognized point cloud data, the machine-readable instructions are executed by the processor to perform following:
performing, by a neural network that has been trained, object recognition on the to-be-recognized point cloud data, and
outputting, by the neural network, the bounding box of the recognized object.

18. The electronic device according to claim 17, wherein the machine-readable instructions are executed by the processor to further perform following:
outputting, by the neural network, a confidence of each bounding box.

19. A non-transitory computer-readable storage medium having stored thereon a computer program that, when executed by a processor, cause the processor to implement following actions:
performing object recognition on to-be-recognized point cloud data to obtain a hounding box of an object in the to-be-recognized point cloud data;
determining to-be-labeled point cloud data according to the bounding box of a recognized object in the to-be-recognized point cloud data;
acquiring a manual annotation box of an object in the to-be-labeled point cloud data; and
determining annotation boxes of objects in the to-be-recognized point cloud data according to the bounding box and the manual annotation box.

20. The non-transitory computer-readable storage medium according to claim 19, wherein the computer program causes the processor to further perform following:
performing the object recognition on the to-be-recognized point cloud data to obtain a confidence of the bounding box of the recognized object; and
in the determining to-be-labeled point cloud data according to the bounding box of the recognized object in the to-be-recognized point cloud data, the computer program causes the processor to perform following:
eliminating a bounding box with a confidence less than a confidence threshold. according to the confidence of the bounding box of the recognized object to obtain a remaining bounding box; and
taking point cloud data outside the remaining bounding box in the to-be-recognized point cloud data as the to-be-labeled point cloud data.
